(19) United States
(12) Patent Application Publication
(10) Pub. No.: US 2026/0065680 A1
(43) Pub. Date: Mar. 5, 2026

(54) Systems and Methods for Video Monitoring of Construction Heavy Equipment and Event Generation Using Artificial Intelligence

(71) Applicant: Dozer.ai, Inc, Oakland, CA (US)

(72) Inventors: Andrew W. Tam, El Cerrito, CA (US); Alamgir Mand, Oakland, CA (US); Anand Asokan, Shelby Township, MI (US); Ryan Herbison, Eau Claire, WI (US); Mitchell R. Weller, El Cerrito, CA (US)

(73) Assignee: Dozer.ai, Inc, Oakland, CA (US)

(21) Appl. No.: 19/312,036

(22) Filed: Aug. 27, 2025

Related U.S. Application Data
(60) Provisional application No. 63/687,718, filed on Aug. 27, 2024.

(51) Int. Cl. G06V 20/52; B60W 30/09; B60W 30/095; E02F 9/20; E02F 9/24; E02F 9/26; G05D 1/622; G05D 107/90; G06T 7/246; G06V 10/774; H04N 7/18; H04N 13/243; H04N 23/698

(52) U.S. Cl. CPC G06V 20/52; B60W 30/09; B60W 30/0956; E02F 9/2033; E02F 9/24; E02F 9/26; G05D 1/622; G06T 7/246; G06V 10/774; H04N 7/181; G05D 2107/90; G06T 2207/10021; G06T 2207/10028; G06T 2207/20081; G06T 2207/30204; G06T 2207/30232; H04N 13/243; H04N 23/698

(57) ABSTRACT

In many embodiments of the invention, a video monitoring system for construction sites includes one or more stereoscopic cameras configured to capture image data from multiple viewpoints over time, one or more 360-degree cameras configured to capture 360-degree image data, an edge device configured to receive the image data from the stereoscopic cameras and the 360-degree cameras, generate three-dimensional point clouds from the image data, recognize fiducial markers within the image data, identify objects and estimate movement of the objects in the point clouds using a plurality of machine learning models, and generate alerts based on the identified movement of the objects, and one or more client devices configured to receive the alerts from the edge device.

### CROSS-REFERENCE TO RELATED APPLICATIONS

The current application claims priority under 35 U.S.C. 119 (c) to U.S. Provisional Patent Application Ser. No. 63/687,718, entitled “Systems and Methods for Video Monitoring of Construction Heavy Equipment and Event Generation Using Artificial Intelligence”, filed Aug. 27, 2024. The disclosure of which is hereby incorporated by reference in its entirety.

### FIELD OF THE INVENTION

The present invention relates generally to video surveillance and more specifically to automated event detection and alerting on construction sites.

### BACKGROUND OF THE INVENTION

Construction sites have a great deal of activity that includes heavy equipment and present numerous hazards to workers and bystanders. Many current safety standards involve merely manual processes that leave a lot of margin for accidents and incidents to occur. Without constant human visibility on all sides of heavy equipment, there cannot be continuous safety monitoring. Ruggedized video monitoring equipment is often too expensive for commercial use.

In 2022, the United States lost 75 million days of productivity in construction, $167 billion in non-fatal injuries, reported 700,000 utility line strikes that caused $1.7 billion in damage, and 1,000 fatalities which cost an average of $1.4 million per incident. Current measures for accident avoidance do not adequately minimize losses and are manual in nature, being subject to human attention and error.

### SUMMARY OF THE INVENTION

In many embodiments of the invention, a video monitoring system for construction sites includes one or more stereoscopic cameras configured to capture image data from multiple viewpoints over time, one or more 360-degree cameras configured to capture 360-degree image data, an edge device configured to receive the image data from the stereoscopic cameras and the 360-degree cameras, generate three-dimensional point clouds from the image data, recognize fiducial markers within the image data, identify objects and estimate movement of the objects in the point clouds using a plurality of machine learning models, and generate alerts based on the identified movement of the objects, and one or more client devices configured to receive the alerts from the edge device.

In several embodiments of the invention, the stereoscopic cameras are mounted on construction equipment.

In some embodiments of the invention, the construction equipment comprises at least one of a backhoe, bulldozer, or excavator.

In further embodiments of the invention, the machine learning models are trained using construction data captured from a construction environment.

In more embodiments of the invention, the alerts comprise safety alerts for potential collisions based on detected objects and distances between the detected objects.

In still further embodiments of the invention, the edge device is configured to predict collision paths based on determined velocities of detected objects and generate the safety alerts when collision thresholds are exceeded.

In still more embodiments of the invention, the edge device is configured to send a vehicle control command limiting movement of a vehicle based upon a predicted collision involving the vehicle.

In many embodiments of the invention, the stereoscopic cameras are further configured to capture environmental condition data and embed the environmental condition data within the image data.

In several embodiments of the invention, the fiducial markers are mounted to stationary and movable portions of vehicles and recognition of fiducial markers is prioritized over identification of objects using image data other than fiducial markers.

In some embodiments of the invention, the machine learning models are trained to recognize raw materials and are configured to output identification of raw materials and their locations.

In further embodiments of the invention, a method for automated event detection on construction sites includes capturing image data over time using one or more stereoscopic cameras each having multiple image sensors, sending the image data to an edge device, generating point clouds from the image data at the edge device, identifying objects in the point clouds and estimating movement of the objects using machine learning models, generating alerts based on the identified objects, and sending the alerts to one or more client devices.

In more embodiments of the invention, the stereoscopic cameras are mounted on construction equipment.

In still further embodiments of the invention, the construction equipment comprises at least one of a backhoe, bulldozer, or excavator.

In still more embodiments of the invention, the machine learning models are trained using construction data captured from a construction environment.

In many embodiments of the invention, generating alerts comprises generating safety alerts for potential collisions based on the identified objects and distances between the identified objects.

In many embodiments of the invention, predicting collision paths based on determined velocities of the identified objects and generating the safety alerts when collision thresholds are exceeded.

Several embodiments of the invention also include sending, from the edge device, a vehicle control command limiting movement of a vehicle based upon a predicted collision involving the vehicle.

In some embodiments of the invention, the stereoscopic cameras are further configured to capture environmental condition data and embed the environmental condition data within the image data.

In further embodiments of the invention, the fiducial markers are mounted to stationary and movable portions of vehicles and recognition of fiducial markers is prioritized over identification of objects using image data other than fiducial markers.

In more embodiments of the invention, the machine learning models are trained to recognize raw materials and are configured to output identification of raw materials and their locations.

Still further embodiments of the invention also include sending video data and logs to one or more cloud servers for storage and post-processing.

### BRIEF DESCRIPTION OF THE DRAWINGS

FIG. 1 illustrates a video monitoring system in accordance with several embodiments of the invention.

FIG. 2 illustrates a vehicle (a backhoe) with two stereoscopic cameras in accordance with several embodiments of the invention.

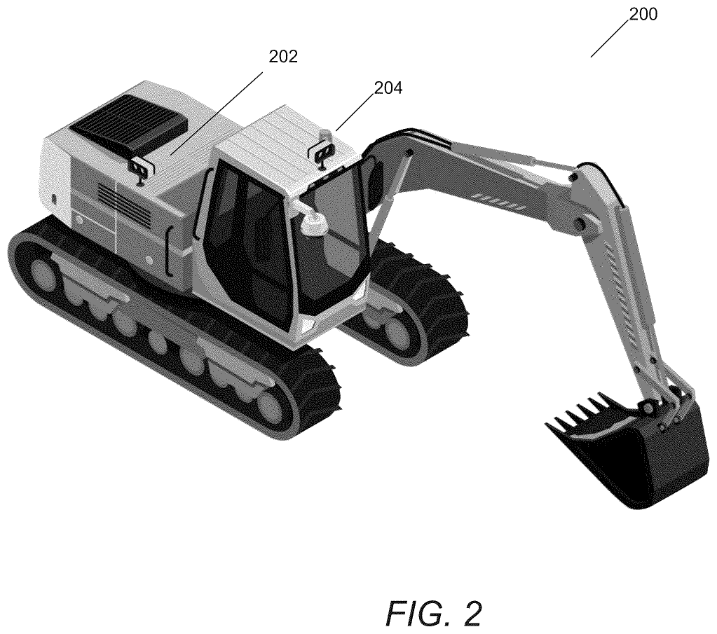

FIG. 3 shows sample images from a stereoscopic camera in accordance with embodiments of the invention.

FIG. 4 shows sample images from stereoscopic cameras and depth map in accordance with embodiments of the invention.

FIG. 5 illustrates a 360-degree camera mounted on a bulldozer in accordance with embodiments of the invention.

FIG. 6 conceptually illustrates an edge device and cameras in accordance with embodiments of the invention.

FIG. 7 shows an image with object recognition labels in accordance with embodiments of the invention.

FIG. 8 shows an example user interface with dashboard in accordance with embodiments of the invention.

FIG. 9 shows an example user interface with overview of jobsites with embodiments of the invention.

FIG. 10 shows an example user interface with live video in accordance with embodiments of the invention.

FIG. 11 shows an example user interface with geolocations in accordance with embodiments of the invention.

FIG. 12 shows an example user interface with completed project updates (utilities, etc.) exported to blueprints and map in accordance with embodiments of the invention.

FIG. 13 shows an example user interface with utility line diagram in accordance with embodiments of the invention.

FIG. 14 is a flow chart showing a process for video monitoring and alert generation in accordance with embodiments of the invention.

### DETAILED DISCLOSURE OF THE INVENTION

Turning now to the drawings, systems and methods for video monitoring of construction heavy equipment and event generation using artificial intelligence are disclosed. Video monitoring systems in accordance with embodiments of the invention enable comprehensive information gathering and situational awareness. Systems can include cameras distributed over a construction worksite, such as being mounted on heavy equipment and stationary positions. Computer vision and depth perception may be utilized on image data from the cameras for object detection and situational awareness using machine learning models. Consequently, the systems can generate alerts to hazards such as potential collisions and personal injury, as well as operator errors. Additional information can be included with alerts, such as retrievable video clips of incidents. The wealth of data produced can also be used in daily summary reports and dashboards to present insights, trends, project overviews and milestones.

### Video Monitoring Systems

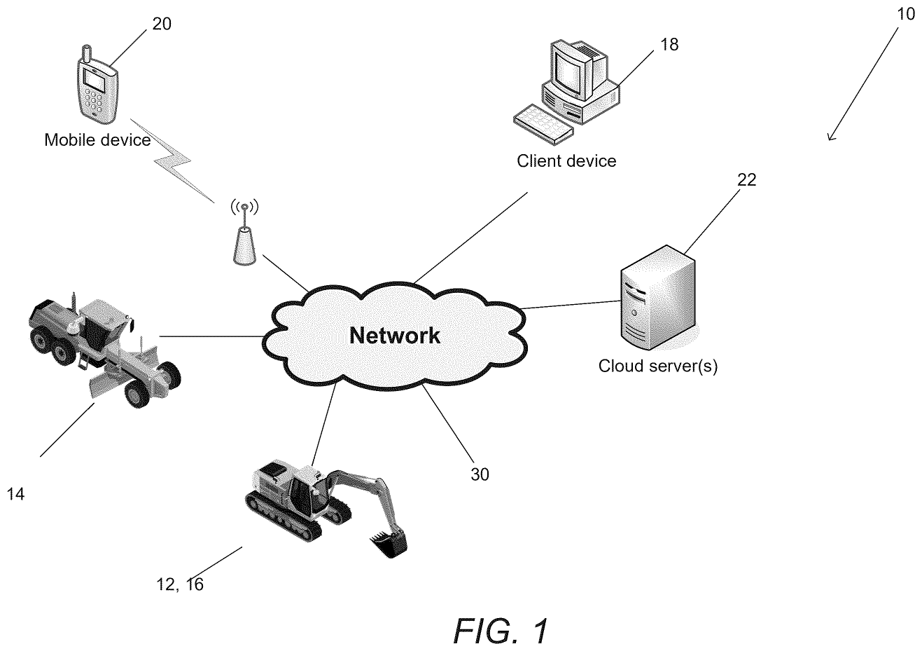

A system diagram of a video monitoring system in accordance with many embodiments of the invention is illustrated in FIG. 1. The video monitoring system 10 includes one or more cameras and sensors 12 that can be mounted on heavy equipment or other types of vehicles, or that may be placed in stationary locations on a construction worksite. As will be discussed in greater detail below, the cameras can capture image and/or video data of the environment for further processing. In several embodiments of the invention, the cameras are stereoscopic cameras having two or more image sensors, which can be used for computer vision and depth perception.

Other cameras can include one or more 360-degree cameras 14 that that can shoot 360-degree pictures or video. In several embodiments of the invention, 360-degree videos can be streamed, stored and retrieved through a user interface, for example by a user after receiving an alert.

One or more edge devices 16 can be co-located on vehicles with cameras and sensors 12 and/or 14 or elsewhere on the worksite. The edge devices can receive image, video and/or sensor data from the cameras 12 and 14. An edge device may create three dimensional (3D) representations of scenes from the image/video data as point clouds or other representations. The edge device may use machine learning models and/or other techniques for image recognition on the image/video data and/or the point clouds and generate alerts for detected objects.

Edge devices can send image/video and sensor data and/or other processed data directly to one or more client devices 18, mobile devices 20, and/or cloud server(s) 22. The data may be stored in the cloud server(s) 22 and provided to client device 18 and/or mobile device 20. In several embodiments of the invention, client device 18 and/or mobile device 20 are configured with a graphical user interface that can display alerts and/or dashboards to visualize or summarize the data.

Any of the cameras 12 and 14, edge device 16, client device 18, mobile device 20, and cloud server(s) 22 may communicate over a network 30. In some embodiments of the invention, cameras 12 and/or 14 may communicate with an associated edge device 16 over a wireless connection (e.g., LTE), local network, or over a wired connection.

### Cameras

In many embodiments of the invention, the cameras and sensors may be placed on vehicles, pieces of heavy equipment, or stationary in areas of a worksite. Fig. shows cameras 202 and 204 mounted on backhoe 200 and pointed in different directions. In many embodiments of the invention, one or more cameras are stereoscopic, i.e., having two or more image sensors. Each image sensor may have its own lens. The image sensors can capture image data that includes a representation of a scene from the viewpoint of each image sensor. The image data may be captured on a continuous basis, e.g., as video or a series of images over time.

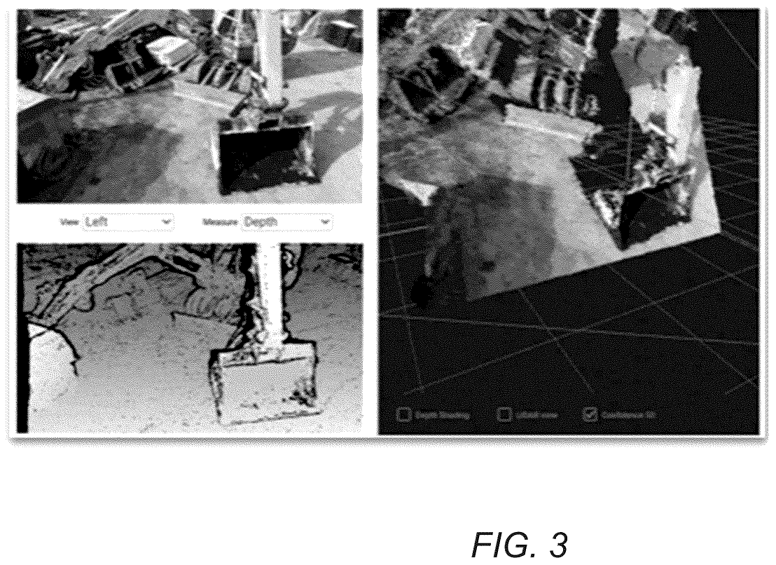

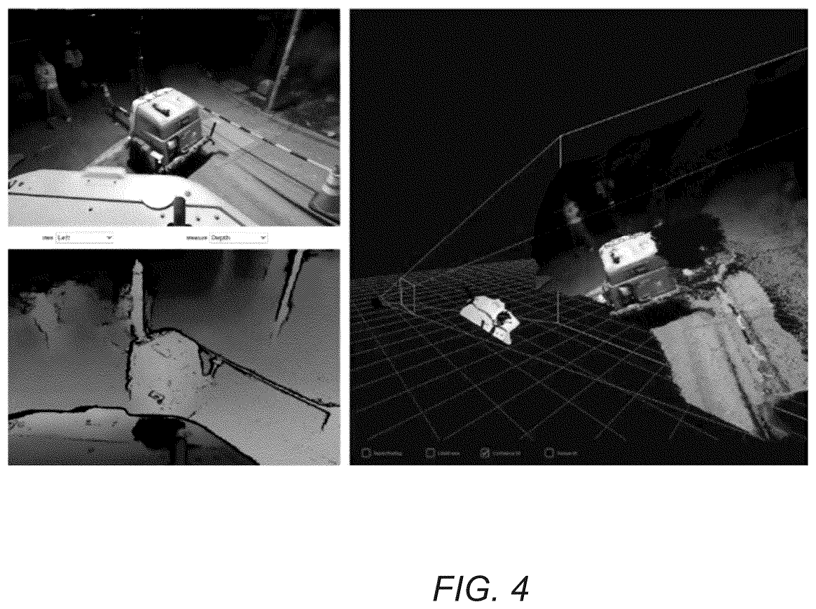

At least some of the data can be represented as frames of RGB (red, blue, green) data in any of a variety of image or video formats (e.g. MPEG, AVI, JPEG, MKV, etc.). In additional embodiments of the invention, the camera (or another device) can create three dimensional (3D) point clouds of the captured scene using the images from the multiple image sensors. Due to the different viewpoints of the image sensors, triangulation can be used to estimate depth. In some embodiments on the invention, the camera can generate point clouds and/or depth information, while in other embodiments an edge device can generate point clouds and/or depth information using image data provided by a camera. A point cloud can reconstruct the environment in 3D, assigning depth information to each pixel or point. These detailed point clouds may be used for facilitating highly precise object identification, accurate classification (e.g., distinguishing between a person, a vehicle, and construction material), and robust tracking of these entities within a dynamic 3D spatial context. In several embodiments of the invention, a camera may calibrate upon startup from newly captured image data to regenerate depth information. FIGS. 3 and 4 show sample images from stereoscopic cameras and depth maps in accordance with embodiments of the invention.

Cameras and sensors in some embodiments of the invention may also capture data on additional conditions in the environment, such as, but not limited to GPS location, barometric pressure, temperature, and/or IMU (inertial measurement unit). The GPS location and/or other information may also be obtained from a vehicle or device that the camera is mounted to. The video and sensor data may be packaged into one video (e.g., MKV, MPEG, AVI, etc.) stream for efficiency in transmitting to an edge device.

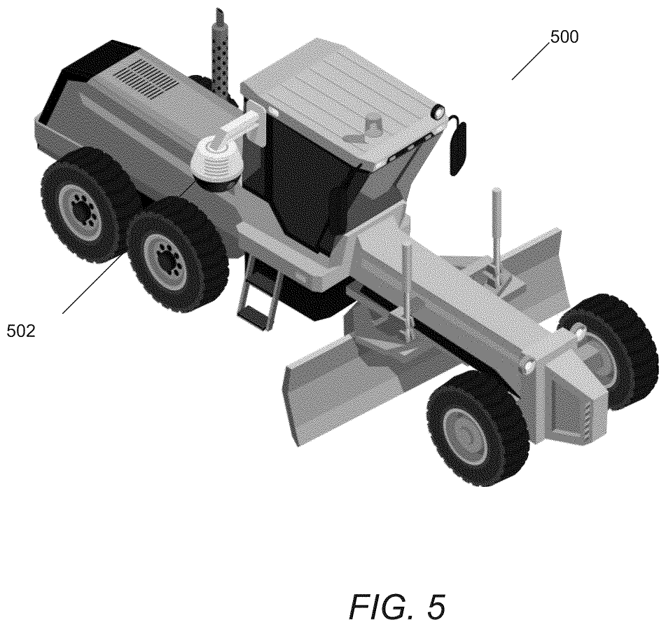

In several embodiments of the invention, one or more cameras are 360-degree cameras. The 360-degree cameras may provide a more encompassing viewpoint of the surrounding environment, even when not capable of capturing depth information. FIG. 5 illustrates a 360-degree camera 502 mounted on a bulldozer 500 in accordance with embodiments of the invention. The camera can capture a horizontal 360-degree view and at least a vertical 180-degree view of the environment.

Some cameras in accordance with embodiments of the invention may be used in a sentry mode when a vehicle is not being operated. If motion is detected by bump or movement sensors, video can be streamed to an edge device. Flood lights may be triggered. Models on an edge device may be run at a lower rate, e.g., 1 to 5 frames per second, and then run at full rate if tampering is detected.

Image data from stereoscopic cameras and 360-degree cameras can be communicated to an edge device that is co-located on a vehicle or in a different area.

### Edge Device

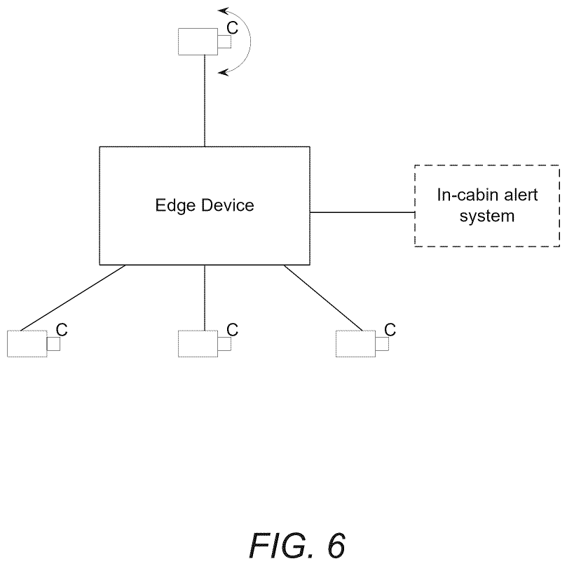

An edge device may receive image data from one or more cameras, store the image data and send it on to client devices or a cloud server. Edge devices may be modular, i.e., each having their own associated cameras such that the system is expandable by adding edge devices. In some embodiments of the invention, one edge device, three stereoscopic cameras, and one 360-degree camera are assigned to a vehicle or heavy equipment. FIG. 6 conceptually illustrates an edge device and cameras in accordance with embodiments of the invention.

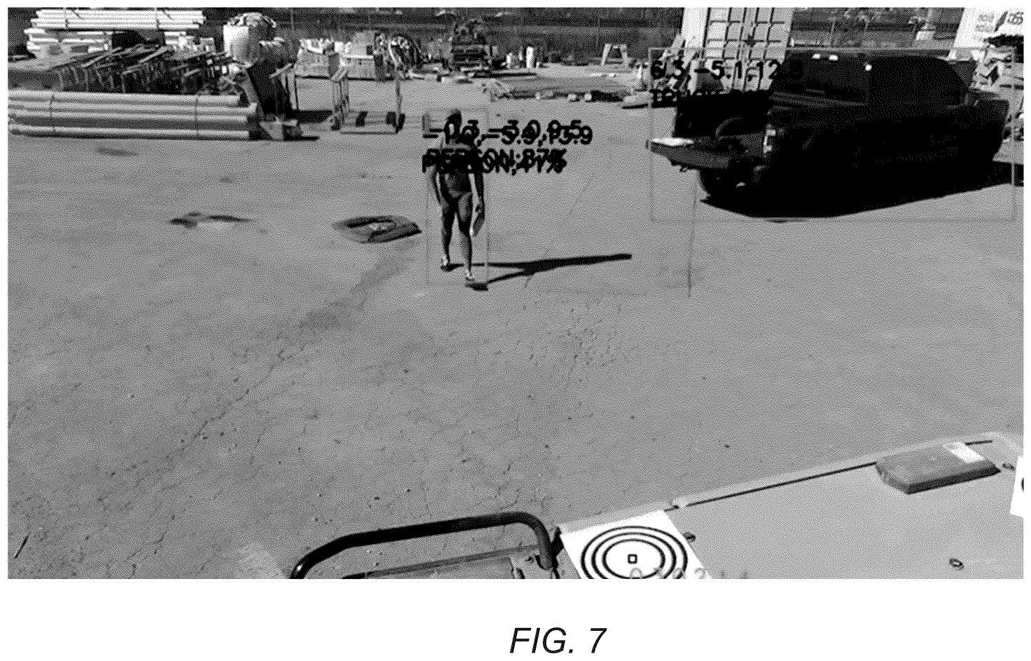

An edge device may use any of a variety of computer vision machine learning models (e.g., models such as YOLOv8 using neural networks) for object detection, classification, and/or segmentation. In some embodiments of the invention, the model(s) may be tuned on hyperparameters and trained with a labeled dataset to identify objects such as, but not limited to, a person, car, truck, boom arm, bucket, or traffic cone, etc. In many embodiments, one or more models are trained using construction data (e.g., captured from a construction environment and/or related to the use of construction equipment), such by using reinforcement learning. These models can undergo extensive training on a large and diverse dataset (e.g., comprising over 150,000 meticulously annotated construction site images), encompassing a wide array of equipment types, personnel, and environmental conditions. This rigorous training enables the models to achieve superior object detection accuracy, exceeding 92% for persons and vehicles at a range of up to 10 meters, and maintaining robust detection performance with over 85% accuracy even at extended ranges of up to 30 meters. The models can perform real-time classification of objects, their states (e.g., moving, stationary), and their interactions. A confidence score may accompany the identification. An example image showing recognition of a person with 87% confidence in accordance with embodiments of the invention is shown in FIG. 7.

Additional embodiments of the invention contemplate use of actor/observer models, parallel reckoning or reconciliation across models, ensemble models, and/or IMU (Inertial Measurement Unit) recognition models. Embodiments of the invention may utilize a multi-model approach.

Further embodiments of the invention perform sensor fusion for entity tracking, that is to determine that an entity seen in one camera is the same entity seen in another camera. This may utilize an ensemble model to run inference across multiple frames and/or calculating on vectors of motion. Entity tracking can be performed, for example, by pixel recognition, that is identifying pixels in different frames that correspond to the same object.

### Image Recognition Processing

In many embodiments of the invention, a data stream (e.g., images or frames of video) can be split or copied so that multiple recognition processes may be performed simultaneously. A first stream may be provided to a computer vision machine learning model as discussed above, while a second stream may be provided to a fiducial marker detector.

Fiducial markers are used in the field of computer vision to establish a visual reference in a scene. A fiducial marker typically includes a computer recognizable pattern that can be readable under different conditions. In some embodiments, a QR code may be used as a fiducial marker. Label that each have a fiducial marker may be strategically placed, for example, on a piece of heavy equipment to mark a body line or part of the vehicle, on obstacles that are difficult to see such as trenches or cliffs, and/or on real (e.g., walls or chain link fence) or conceptual barriers or boundaries. In this way, the edge device and/or other devices in a video monitoring system can recognize and determine locations for objects that have been intentionally labeled ahead of time. In further embodiments, fiducial markers may also be used for calibration of cameras. In many embodiments, the fiducial markers are unique from each other within a particular video monitoring system. In some embodiments, the mapping (assignment of a fiducial marker to a particular object) may be changed for some markers, while other markers may not be remapped.

A computer vision machine learning model may be designed to visually identify and classify objects (e.g., people and vehicles) with a determined probability and a distance measurement. A fiducial marker detector may be designed to identify objects by recognizing labels bearing fiducial markers and a distance measurement. In this way, a combination of a computer vision machine learning model and fiducial marker detector can be complementary in identifying different types of objects (although some may coincide to the same real-world object, such as a vehicle) and/or in different ways. In certain embodiments of the invention, fiducial markers can hold a higher priority score than recognition performed by other types of computer vision. Classes of construction related assets and entities that can be identified in a video monitoring system can include, but are not limited to humans, animals, vehicles (cars, trucks, etc.), heavy equipment, cones, PPE (personal protective equipment), and other miscellaneous categories such as objects marked with yellow iron and blaze orange. Distances that are output by the computer vision machine learning model may be compared or computed against distances that are output by the fiducial marker detector for the same image or frame of video, e.g., for the purposes of alerts and other analysis.

Material detection can be performed by identifying certain material (cinder blocks, lumber, dirt, etc.) visually using machine learning models or other techniques. The material type and/or location can then be tagged by the system.

### Alerts

As mentioned above, a computer vision machine learning model or group of models may produce alerts based on predictive analytics for hazard detection, e.g., using detected objects and distance between them. Alerts can be configured to be sent to an in-cabin unit, desktop client, and/or mobile client. Categories of alerts can include, but are not limited to: safety, policy, and material detection. Many embodiments of the invention can estimate proximity down to 10 cm accuracy from the point cloud.

Safety alerts can include potential collisions. This goes beyond simple proximity alerts by actively modeling the trajectories and velocities of all identified entities (equipment, personnel, and dynamic obstacles) within the operational environment. Machine learning models can analyze these dynamic parameters to predict potential collision paths with high confidence. This predictive capability enables the system to forecast potential incidents several seconds in advance, providing a critical window for intervention.

For example, an object may be detected as a vehicle with a boom arm. The machine learning model(s) can determine a vehicle maximum speed based on the vehicle type and a swing distance and/or max velocity of the boom arm. Based on the combined determined velocities and the presence of another object (e.g., a human) on the scene, a collision path can be predicted. Thresholds for alerting of a collision can be set as a fixed decision tree. Thresholds may be given by an administrator of the system and/or may be vary depending on the type of environment (e.g., a tight street vs. a wide-open street). Given the raw measurements and classifications from the machine learning model, the decision tree can be traversed to determine whether to send an alert. Additionally, the event may be tagged and reported on a dashboard.

In some embodiments of the invention, the video monitoring system can use multi model and/or multi modal approaches. A multi model approach utilizes multiple models that each make an estimate of object (e.g., vehicle or asset) location and/or movement and custom scoring is used to evaluate and consolidate the estimates. A multi modal approach can utilize other information in addition to image data, such as, but not limited to GPS location information and other sensor information discussed further above, as well as CAN bus (Controller Area Network bus) data and vehicle control signals from a vehicle. Using information from vehicle/motion control signals, fiducial markers, and/or image data captured of particular movements of a vehicle, machine learning models can be trained on those movements.

Policy alerts can implement policies such as those designed to prevent hazards, for convenience, or to comply with standards or regulations. For example, a policy may be to prevent other vehicles or equipment being located within 1 meter of an excavator. A policy alert can be generated if any such objects are detected within the set distance.

### Direct Automated Equipment Actuation

Upon the detection and prediction of a high-probability collision event or a critical policy violation (e.g., unauthorized entry into a hazardous zone, or an operator ignoring immediate proximity warnings), the system can be configured to directly interface with the heavy equipment's onboard control systems to trigger automated, autonomous intervention. This constitutes a closed-loop safety mechanism that extends beyond merely alerting human operators to actively mitigate risks. The automated control actions can include:

Automatic Vehicle Braking: In situations where an imminent collision is predicted, the system can send a command to the equipment's braking system to initiate an emergency stop or a controlled deceleration. This actuation typically occurs within a latency of less than 0.5 seconds from the high-confidence prediction, minimizing reaction time and reducing collision severity.

Engine Shut-Off or Power Reduction: For critical violations or immediate danger, the system can issue commands to shut down the equipment's engine or significantly reduce its power output, effectively immobilizing it or rendering it safe until the hazard is cleared.

Speed Reduction: If equipment approaches a hazardous zone or exceeds a predefined speed limit, the system can automatically reduce its operational speed, enforcing compliance and providing an additional safety margin.

Dynamic Zone Denial/Restriction: The system can enforce real-time policy, such as dynamically denying equipment access to unsafe zones by limiting its operational range or functionality when it detects a violation, or by restricting specific movements (e.g., preventing a crane from swinging over a prohibited area).

This direct actuation capability may utilize secure communication protocols and standard industrial interfaces, such as CAN Bus (Controller Area Network) or J1939, which are widely supported by modern heavy equipment. For older or legacy machines, retrofit kits can be integrated to enable these automated control functions. This capability can transforms a safety system from a reactive warning tool into a proactive, intelligent, and autonomous risk mitigation platform.

### Cloud Servers

The data from an edge device can be communicated to one or more cloud servers. The edge device can send image/video data, audio, event data, postprocessing on events (tagged by the edge device), IMU data, and/or sensor readings to a cloud server. The events and other data may be packaged, for example, within video (e.g., MPEG, AVI, MKV, etc.) fragments in a stream.

The cloud server can store the data in a database by creating entries. For each event, the cloud server can generate assets to assist with display in a user interface, such as GIFs, thumbnails, and short clips. Live or historical video can be streamed from the cloud server to client devices.

### Client Devices

Client devices in accordance with embodiments of the invention can include any of a variety of devices configured with an interface and to receive data from a cloud server and/or edge device. Client devices can include, but are not limited to, in-cabin units, desktop clients, and mobile clients.

### In-Cabin Units

In several embodiments of the invention, in-cabin units are co-located in a piece of heavy equipment or other vehicle that has one or more cameras and/or edge devices. An in-cabin unit can be a tablet or other device designed with a user interface for an operator of the vehicle. The in-cabin unit may show a persistent video stream of one or more stereoscopic cameras on the vehicle. In some embodiments of the invention, an in-cabin unit can communicate directly (by wired or wireless data connection) with an edge device. Video can be provided in real-time from cameras on the vehicle to the in-cabin unit through the edge device. The video can be shown on a display. The display may also show proximity measurements and event information.

Additional visualizations can be shown on the display, such as a 3D models and point cloud tessellations of the vehicle exterior created using image data from the stereoscopic cameras. The display can also show an overhead map of the area.

Additional data points can be shown on the display. In some embodiments of the invention, a cloud server or other service can store custom markups of the worksite. For example, a safety director may identify and mark 10-meter power lines on a map. When an operator approaches the location where power lines are marked, a reminder can be displayed to remind the operator to be aware of the 10-meter power lines.

In some embodiments, an in-cabin unit may be a device with a simple indicator rather than a graphical display, such as an LED ring or lights.

In some embodiments of the invention, an in-cabin unit includes an intercom or radio, which can be used to communicate to other operators or workers within the area. A speaker and/or a Bluetooth headset can be used for communication and may also give audible feedback.

### Desktop Clients

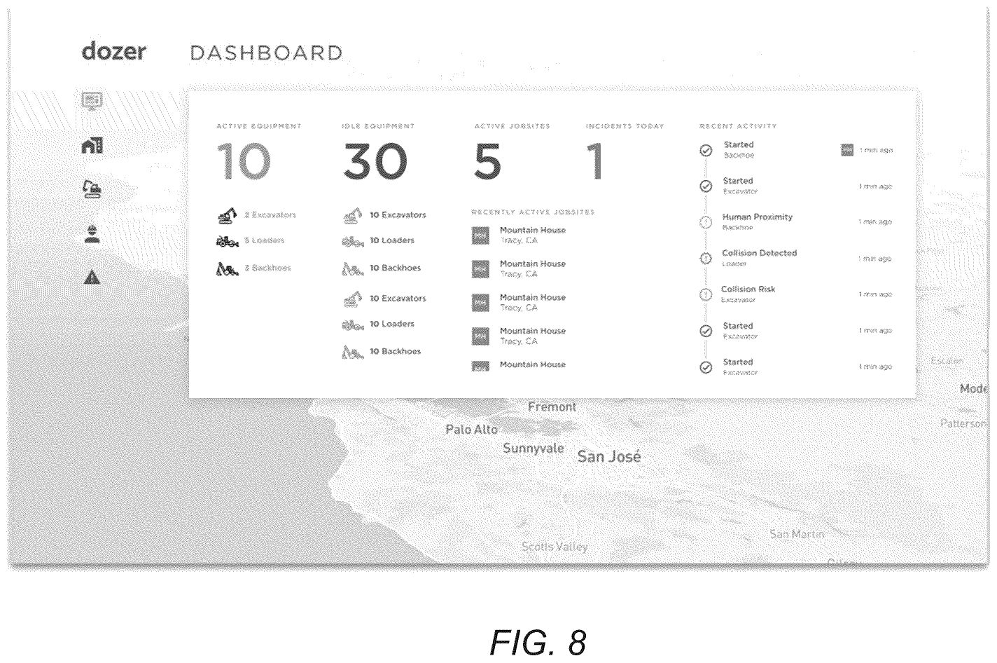

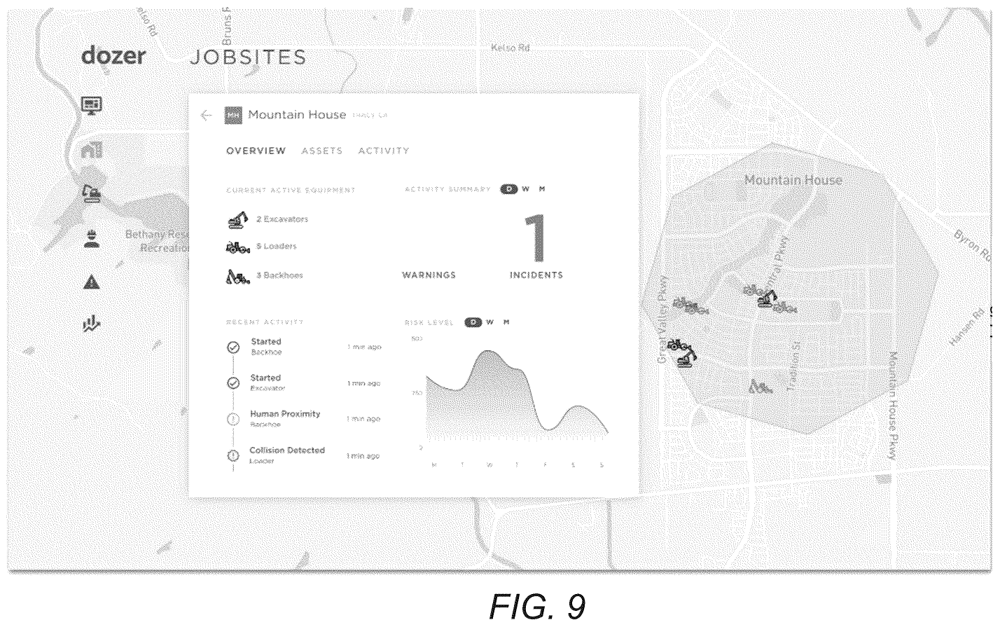

In several embodiments of the invention, desktop clients can receive data over a network and display a user interface designed for users that may be on or off the worksite, such as supervisors and foremen. A desktop client can display a dashboard with an overview of total characteristics for a worksite or number of worksites acquired from edge devices. The dashboard may show, for example, number of active equipment, number of idle equipment, number of active jobsites, number of incidents, and recent activity of incidents. An example dashboard in accordance with embodiments of the invention is shown in FIG. 8. Another screen in the user interface showing characteristics of a jobsite in accordance with embodiments of the invention is shown in FIG. 9.

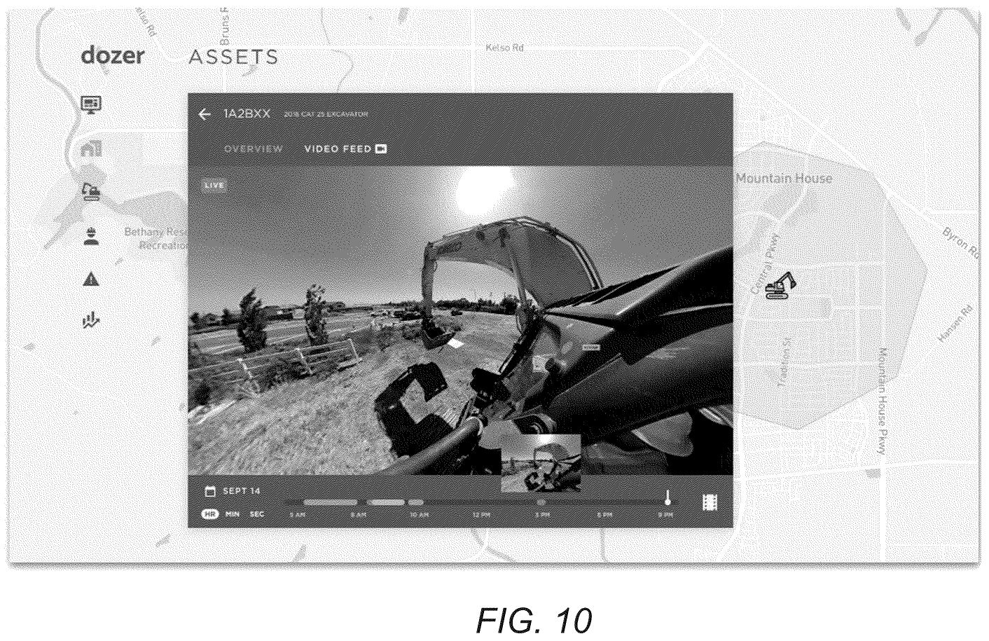

Live video can be viewed when a camera is selected, as well as historical video. For example, a user interface may show an image of an event from a stereoscopic camera as a picture-in-picture superimposed on an image or video from a 360 camera. A video feed within the user interface in accordance with embodiments of the invention is shown in FIG. 10. Colored bars can indicate proximity or likelihood of collision. For example, green can indicate no other objects within close distance, yellow can indicate some objects within close distance, and red can indicate an imminent danger of collision.

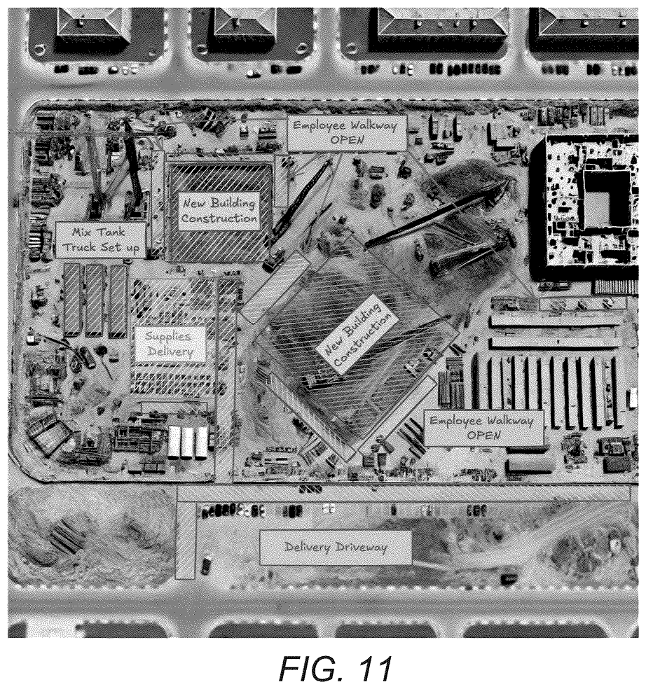

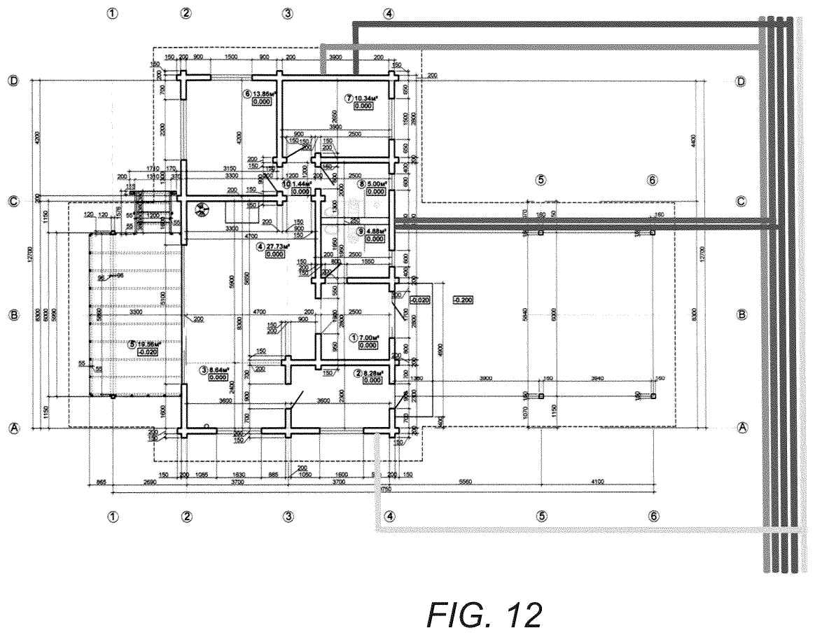

The user interface may also show maps of a jobsite and locations for various marked out objects (walkways, material drop sites, new construction, etc.) such as the example shown in FIG. 11. The designations can be used to track movement and send reminders to operators as discussed further above. FIG. 12 shows an example the export of the finished objects (utilities, materials, etc.) as observed by a video monitoring system in accordance with embodiments of the invention, which can be used to update municipal and building records and blueprints from a jobsite. As objects are being built by a construction team, cameras and sensors may collect images and other data that record the progress and location. The information can used to recreate the objects within a virtual representation of the jobsite.

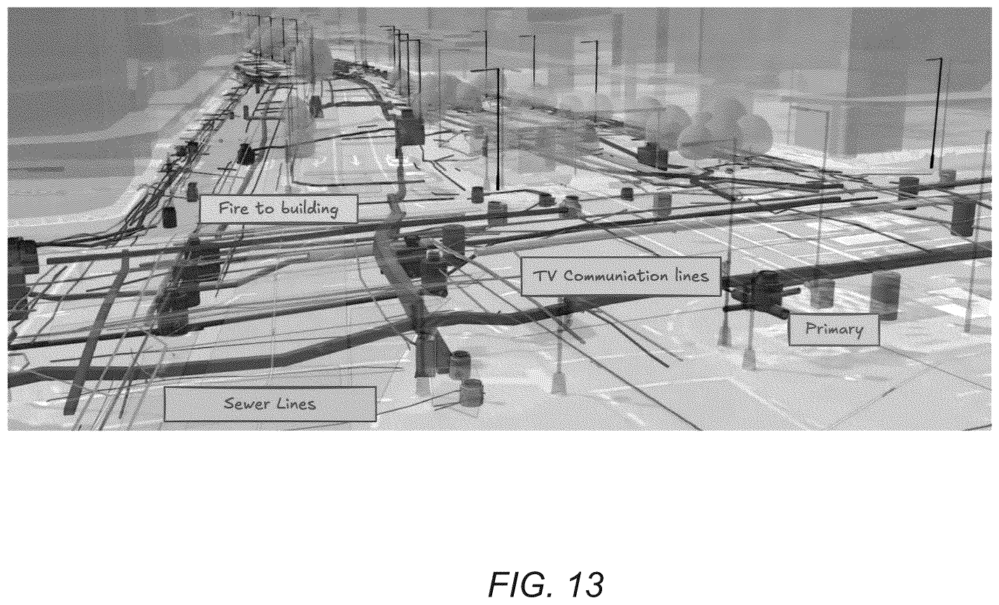

In some embodiments of the invention, image recognition can identify features of the jobsite that can inform locations where work or movement should be restricted because of danger of damage. FIG. 13 shows an example user interface with utility line diagram in accordance with embodiments of the invention. The utility lines could be identified from image data.

In additional embodiments of the invention, event data can be fed to other platforms for visualizations, for example by using API's (application programming interface). Data can be provided to site management software (e.g., Procore) to perform tasks such as generate sites safety reports, security monitoring, or pan video to determine whether key metrics are hit.

### Mobile Clients

In several embodiments of the invention, mobile clients can implement interfaces such as those described above with respect to desktop clients. Mobile clients can have other functionality, such as indicating to an operator what their assigned driving zones and delivery zones are.

In additional embodiments, an interface may provide an augmented reality (AR) view, where live video from an onboard camera of the mobile device is shown. The video can be adjusted based on a gyroscope, accelerometer, or other type of positional or motion sensor on the mobile device.

In the AR view, the camera can be pointed at a vehicle. When the vehicle is selected, it can be identified (e.g., visually or by a QR tag) and an interface can be shown for that vehicle. The interface can provide a number of capabilities, such as, but not limited to, adjusting thresholds, showing historical events, or showing live video. In some embodiments, audio communication can be opened with the operator in the vehicle.

The AR view can be used to give directions. The camera can be pointed at a location, and the mobile device can determine a path from the geolocation of the device and the geolocation of the selected location. In several embodiments, the location can be tagged with a material (e.g., dirt, rock) or other item that is meant to be delivered to the location.

### Processes for Video Monitoring

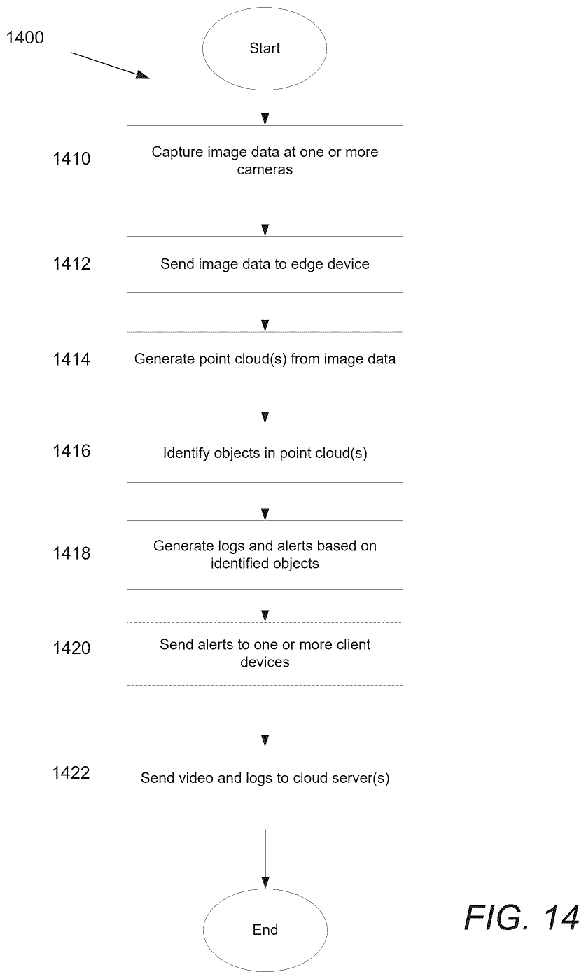

FIG. 14 shows a flow chart for video monitoring in accordance with embodiments of the invention. If the devices (e.g., cameras, sensors, edge devices, etc.) are off, they may be turned on. Initialization and calibration of the cameras and sensors can occur, and video/image data may start streaming [1400]. Image/video and sensor data from one or more cameras are collected [(1410). As discussed further above, cameras can include one or more stereoscopic cameras with multiple image sensors that can each capture images from their own viewpoints. Cameras can also include one or more 360-degree cameras.

The video/image and sensor data are sent to edge devices from the cameras, where each camera is associated with at least one edge device. The video/images and sensor data are analyzed by the edge device (1412). Point clouds, motion vectors and depth information are generated from at least some of the video/image and sensor data (1414). In several embodiments of the invention, video/image data from stereoscopic cameras can be used.

Objects are identified by recognition techniques, such as AI model(s) discussed further above, and depth/positional information is analyzed (1416). System logs and alerts are generated by the data analysis (1418). Alerts can be generated for types of events such as policy, safety, and material detection in real-time. Event alerts can be sent to the dashboard and to one or more client devices (1420). Certain alerts pertaining to a particular vehicle may be sent to an in-cabin unit in that vehicle. Video, alerts and logs can be sent to the cloud server(s) for post processing and storage (1422). Client devices may select and retrieve historical videos, alerts, and logs from the cloud server(s) by selection through a user interface.

Although the description above contains many specificities, these should not be construed as limiting the scope of the invention but as merely providing illustrations of some of the presently preferred embodiments of the invention. Various other embodiments are possible within its scope. Accordingly, the scope of the invention should be determined not by the embodiments illustrated, but by the appended claims and their equivalents.

What is claimed is:

1. A video monitoring system for construction sites, comprising:
one or more stereoscopic cameras configured to capture image data from multiple viewpoints over time;
one or more 360-degree cameras configured to capture 360-degree image data;
an edge device configured to receive the image data from the stereoscopic cameras and the 360-degree cameras, generate three-dimensional point clouds from the image data, recognize fiducial markers within the image data, identify objects and estimate movement of the objects in the point clouds using a plurality of machine learning models, and generate alerts based on the identified movement of the objects; and
one or more client devices configured to receive the alerts from the edge device.

2. The video monitoring system of claim 1, wherein the stereoscopic cameras are mounted on construction equipment.

3. The video monitoring system of claim 2, wherein the construction equipment comprises at least one of a backhoe, bulldozer, or excavator.

4. The video monitoring system of claim 1, wherein the machine learning models are trained using construction data captured from a construction environment.

5. The video monitoring system of claim 1, wherein the alerts comprise safety alerts for potential collisions based on detected objects and distances between the detected objects.

6. The video monitoring system of claim 5, wherein the edge device is configured to predict collision paths based on determined velocities of detected objects and generate the safety alerts when collision thresholds are exceeded.

7. The video monitoring system of claim 5, where the edge device is configured to send a vehicle control command limiting movement of a vehicle based upon a predicted collision involving the vehicle.

8. The video monitoring system of claim 1, wherein the stereoscopic cameras are further configured to capture environmental condition data and embed the environmental condition data within the image data.

9. The video monitoring system of claim 1, wherein the fiducial markers are mounted to stationary and movable portions of vehicles and recognition of fiducial markers is prioritized over identification of objects using image data other than fiducial markers.

10. The video monitoring system of claim 1, wherein the machine learning models are trained to recognize raw materials and are configured to output identification of raw materials and their locations.

11. A method for automated event detection on construction sites, comprising:
capturing image data over time using one or more stereoscopic cameras each having multiple image sensors;
sending the image data to an edge device;
generating point clouds from the image data at the edge device;
identifying objects in the point clouds and estimating movement of the objects using machine learning models;
generating alerts based on the identified objects; and
sending the alerts to one or more client devices.

12. The method of claim 11, wherein the stereoscopic cameras are mounted on construction equipment.

13. The method of claim 12, wherein the construction equipment comprises at least one of a backhoe, bulldozer, or excavator.

14. The method of claim 11, wherein the machine learning models are trained using construction data captured from a construction environment.

15. The method of claim 11, wherein generating alerts comprises generating safety alerts for potential collisions based on the identified objects and distances between the identified objects.

16. The method of claim 15, further comprising predicting collision paths based on determined velocities of the identified objects and generating the safety alerts when collision thresholds are exceeded.

17. The method of claim 11, further comprising sending, from the edge device, a vehicle control command limiting movement of a vehicle based upon a predicted collision involving the vehicle.

18. The method of claim 11, wherein the stereoscopic cameras are further configured to capture environmental condition data and embed the environmental condition data within the image data.

19. The method of claim 11, wherein the fiducial markers are mounted to stationary and movable portions of vehicles and recognition of fiducial markers is prioritized over identification of objects using image data other than fiducial markers.

20. The method of claim 11, wherein the machine learning models are trained to recognize raw materials and are configured to output identification of raw materials and their locations.

21. The method of claim 11, further comprising sending video data and logs to one or more cloud servers for storage and post-processing.
